(19) United States
(12) Patent Application Publication
(10) Pub. No.: US 2022/0250645 A1
(43) Pub. Date: Aug. 11, 2022

(54) METHOD FOR CONTROLLING A PLURALITY OF DRIVING FUNCTIONS IN AN AUTOMATED OR AUTONOMOUS VEHICLE

(71) Applicant: Robert Bosch GmbH, Stuttgart (DE)

(72) Inventors: Lukas Koenig, Grossbottwar (DE); Michael Messer, Adolzfurt (DE); Sarah Weissenberger, Durach (DE); Thorsten Allgeier, Untergruppenbach (DE)

(21) Appl. No.: 17/649,301

(22) Filed: Jan. 28, 2022

(30) Foreign Application Priority Data
Feb. 9, 2021 (DE) 10 2021 201 212.4

(51) Int. Cl. B60W 60/00; B60W 30/14; B60W 50/00; G05B 17/02

(52) U.S. Cl. CPC B60W 60/001; B60W 30/14; B60W 2050/0037; G05B 17/02; B60W 50/00

(57) ABSTRACT

A method for controlling a plurality of driving functions in an automated or autonomous vehicle, a control unit designed to carry out the method, a computer program, and a machine-readable memory medium on which the computer program is stored are provided. In the method, the plurality of driving functions is described in each case by finite state machines. At least one finite state machine is of the Moore type, and includes a structure with a finite set of states. The states are linked to one another via edges. An edge defines from the finite set of states a transition from a starting state to a target state, in that an associated edge condition is true or false. The finite state machine is accessible during runtime based on the structure, so that an access to the states and the edges is made possible to change the states and/or the edges.

### CROSS REFERENCE

The present application claims the benefit under 35 U.S.C. § 119 of German Patent Application No. DE 10 2021 201 212.4 filed on Feb. 9, 2021, which is expressly incorporated herein by reference in its entirety.

### FIELD

The present invention relates to a method for controlling a plurality of driving functions in an automated or autonomous vehicle. Moreover, the present invention relates to a control unit for the automated or autonomous vehicle, and a computer program and a machine-readable memory medium on which the computer program is stored.

### BACKGROUND INFORMATION

The use of finite state machines of the Moore type for robot control is described in König, L. et al.: “Decentralized evolution of robotic behavior using finite state machines,” International Journal of Intelligent Computing and Cybernetics, 2:695-723, 2009.

### SUMMARY

In accordance with the present invention, a method for controlling a plurality of driving functions in an automated or autonomous vehicle is provided. In accordance with an example embodiment of the present invention, the plurality of driving functions is described in each case by finite state machines. At least one finite state machine is of the Moore type, and includes a structure with a finite set of states including a starting state, the states being linked to one another via edges. An edge defines a possible transition from a starting state to a target state, in that an associated edge condition may be true (active) or false (inactive). The at least one finite state machine is accessible during runtime based on the structure, so that an access to the states and the edges is made possible in order to change the states and/or the edges. The accessibility during runtime may be expressed via the visualization capability of the FSM during runtime and via its changeability during runtime. In particular, the state of the FSM during runtime is unambiguously known; i.e., the states of the provided FSM are explicit. This means that the FSM together with its components, due to its structure as a data structure, i.e., as an object, is completely available in a memory medium of a computer or of a control unit, for example, and may be automatically further processed. Due to its structure, the provided FSM, i.e., the provided model, is particularly advantageously usable for software verification, i.e., so-called “model checking,” in which structural and semantic properties of a driving function may be checked directly at the algorithm with the aid of a formal language, for example linear temporal logic (LTL), without a simulation or practical implementation in a vehicle. It is possible to establish model checking as part of a continuous integration toolchain. Semantic properties may include, for example, properties with regard to traffic regulation (“right before left” rule when entering intersections, etc.), driving safety, or driving comfort. Structural properties may include, for example, properties that may result in a system deactivation or shutdown taking place, provided that the conditions for an activation of the driving function are not satisfied. In addition, with the aid of the provided FSM, states that are no longer departed from, so-called “deadlocks,” may be identified at the compilation time or runtime.

The provided FSM may be automatically translated into other equivalent representations. Alternatively, a form is also possible that is suitable for other methods of formal verification. The FSM may advantageously also be used directly in the product, so that the verified version of the FSM, i.e., of the driving function, corresponds exactly to the version of the driving function used in the vehicle. The provided FSM is advantageously adapted to the model checking, and in particular within the scope of the model checking as stated above, may contribute to the improvement of driving safety and reliability of the driving function in an automated or autonomous vehicle, as well as for system validation. In addition, with the aid of the provided FSM structure, strict quality requirements, for example the Safety Of The Intended Functionality (SOTIF) standards and guidelines, may be checked more satisfactorily. Furthermore, the FSMs that are used for describing the plurality of driving functions are not limited to the Moore type as a finite transductor, and may also include FSMs of the Mealy type.

According to a further specific embodiment of the present invention, a change of a state and/or of an edge includes a removal of a state and/or of an edge. Since the FSM is present entirely as a data structure during runtime, changes in the FSM may advantageously be made directly during runtime and do not require a system restart. What takes place in the FSM may be advantageously tracked based on the provided structure of the FSM, even after the compilation operation of the program in which the FSM is implemented. The internal behavior of the FSM, described by the number of states and the type of transitions with edge conditions (“Under which circumstances is a change made from state A into state B”), is thus advantageously “transparent” at any point in time. This means that at any point in time, the overall structure of the FSM is known and may be utilized for automatic processes.

In a further specific embodiment of the present invention, the edges include inputs and the states include outputs. The inputs and outputs are described with the aid of system variables and a formula language. At least one system variable in an output is linked to an output function that is called up if the state in question arises. The output function utilizes an output operator to change the at least one system variable. The edge conditions may also be a function of system variables. The edge conditions may in each case correspond to state transition functions and may be expressed as a formula. The FSM is advantageously incorporated into the vehicle system, in that the system variables define which transitions are made, and the states in each case trigger actions, i.e., changes of system variables. The formula language is used to define the transitions, i.e., to formulate the edge condition, to allow the system variables to be linked to one another.

The system variables include input variables and output variables, it being possible to link the input variables to a user interaction. Thus, even complex structures in the transitions may advantageously be made accessible during runtime in a consistent form. In particular, it may thus be ensured that system variables are changed only by FSM-like structures instead of by an external change. For example, the output operator may be designed as a set operator in order to assign a new value to a system variable. In contrast to FSMs, which respond to events, the provided FSM due to its structure is triggered by calling up a step function, which requires no further parameters and converts the FSM into the next state while carrying out the associated output functions.

A state transition may be active if the edge condition is considered to be satisfied. This means that if the edge condition includes only one system variable, a Boolean “true” value of the system variables, for example, may result in an active transition of the provided FSM. The edge condition may also include a more complex formula with operators and functions. Various implementations of the response to deadlocks (state without active transitions) or nondeterminism (state with more than one active transition) are advantageously possible. The provided FSM may also be implemented as a deterministic FSM, and accordingly offers the greatest possible flexibility in the implementation.

In a further specific embodiment of the present invention, the formula language includes logical operators and/or comparative operators and/or arithmetic operators and/or output operators and a range of numbers. The formula language itself is representable as a structure of a finite state machine. If the formula language itself is representable as an FSM, an automatic translation of the FSM may advantageously take place and therefore model checking may be carried out. The implementation effort may be advantageously reduced by utilizing simple structures for the formula language. In particular for the application of the model checking, loops in the FSM may be dispensed with in order to reduce the complexity. The formula language may be simply represented in the form of a tree structure, which in turn is representable as an FSM. The range of numbers (including floating point numbers) and the arithmetic, based on the provided FSM structure, are also advantageously expanded compared to FSMs that are used in the context of robot control.

In a further specific embodiment of the present invention, an output function is dividable into a structure of a lower-order finite state machine, provided that the output function in a state includes at least two output operators. This may advantageously reduce the complexity of the FSM structure and improve the unambiguous determinability of the state of the FSM. The FSM may advantageously also include lower-order FSMs for easier further processability. An output function may include C++ program code, for example, so that the states include a mixed form character made up of program code and an FSM structure, in contrast to conventional FSM structures. In particular, the output functions in the states with mixed form character may be subdivided into lower-order FSM structures.

In a further specific embodiment of the present invention, the edge condition includes a priority with which an execution sequence of the edges is established. In this way, nondeterminism (multiple present active state transitions from one state to a successor state) that is present may be easily dealt with by establishing an execution sequence. The behavior of the FSM may thus be completely determined at any point in time, and therefore is always trackable.

In a further specific embodiment of the present invention, the structure of the at least one finite state machine is representable as a graph. The at least one finite state machine, based on the structure, is implementable with the aid of an object-oriented programming technique. The provided FSM structure is advantageously universally implementable in any programming language, regardless of the platform, and is thus flexibly adaptable to the particular requirements. The output functions of the FSM, which for example may include arbitrarily branched if/else instructions and an arbitrary number of set operators, advantageously allow programming that is highly oriented toward conventional programming, for example in C++.

In a further specific embodiment of the present invention, a driving function is designed as an adaptive cruise control system of the automated or autonomous vehicle. In one alternative embodiment, the driving function may be designed as a lane-keeping assistant, for example. The provided FSM may in particular advantageously be fully automatically checked for numerous structural and semantic properties. These include purely structural properties such as: “If the conditions for an activation of the driving function are not satisfied, the system in any case will either not activate or switch off,” as well as complex semantic properties such as: “No violations of the ‘right before left rule’ result when an intersection is entered.” This advantageously already allows error detection in much earlier phases of development, not just in subsequent testing, and in particular does not require a large number of test kilometers to be driven. In addition, errors which in actual traffic are so infrequent that they may possibly never occur during testing may advantageously be identified. This is advantageous in particular when, for example for level 3 vehicles, i.e., vehicles that are at least temporarily fully autonomous, complicated algorithms are used whose correctness is not readily apparent, or when multiple algorithms cooperate concurrently in a fairly complex interaction.

Moreover, a control unit is provided which is designed to carry out the above-mentioned method. In the implementation that is accessible during runtime, the FSM may advantageously be used directly on a computer in the development vehicle during the development period, and may be visualized during travel (for debugging, for example). On this basis, for example C++ program code which is executed by the control unit in the final vehicle for controlling the driving function, based on the provided FSM structure, may be automatically generated.

Furthermore, a computer program and a machine-readable memory medium on which the computer program is stored are provided. The computer program includes commands which, when the computer program is executed by a computer, prompt the computer to carry out the above-mentioned method. This provides, in particular during the development period, a high level of flexibility and ease of practicability.

The advantageous embodiments and refinements of the present invention explained above and/or set forth below, except in cases of clear dependencies or incompatible alternatives, for example, may be applied individually or also in arbitrary combination with one another.

The above-described properties, features, and advantages of the present invention as well as the manner in which they are achieved will become clearer and more understandable in conjunction with the following description of exemplary embodiments, which are explained in greater detail with reference to the figures.

### BRIEF DESCRIPTION OF THE DRAWINGS

FIG. 1A shows a schematic illustration of a computer and a machine-readable memory medium, in accordance with an example embodiment of the present invention.

FIG. 1B shows a schematic illustration of a control unit in a vehicle, in accordance with an example embodiment of the present invention.

FIG. 2 shows a schematic illustration of a tree structure for implementing a formula language for a finite state machine for controlling a driving function of a vehicle in FIG. 1B, in accordance with an example embodiment of the present invention

FIG. 3 shows a schematic illustration of a first specific embodiment of a finite state machine based on the formula language in FIG. 2, in accordance with the present invention.

FIG. 4 shows a schematic illustration of a second specific embodiment of a finite state machine for controlling a further driving function of the vehicle in FIG. 1B, in accordance with the present invention.

It is pointed out that the figures are merely schematic and not true to scale. In this sense, components and elements shown in the figures may be illustrated in an overly large scale or in reduced scale for better understanding. In addition, it is pointed out that the reference numerals in the figures have been selected to be unchanged when elements and/or components having an identical design are involved.

### DETAILED DESCRIPTION OF EXAMPLE EMBODIMENTS

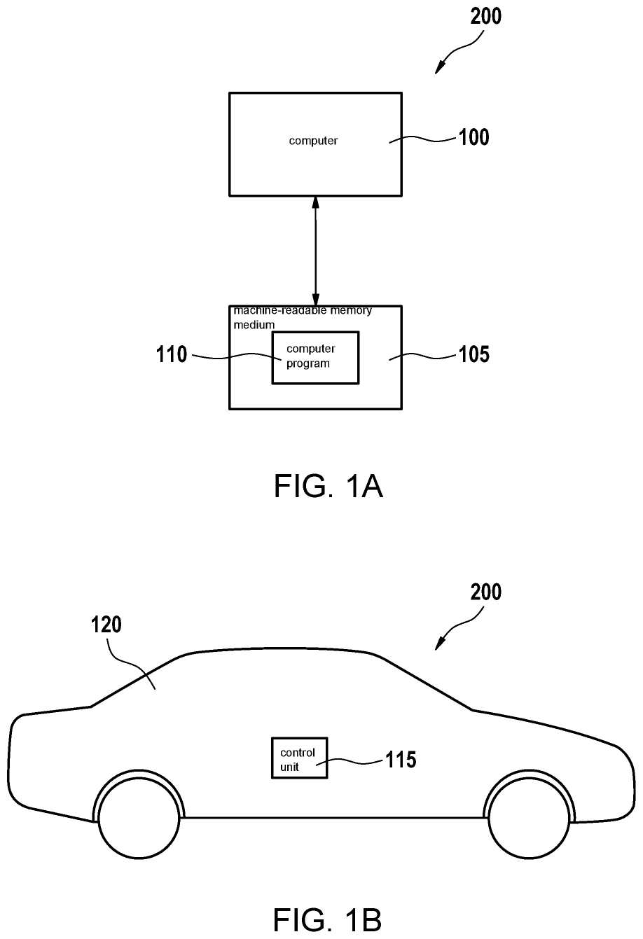

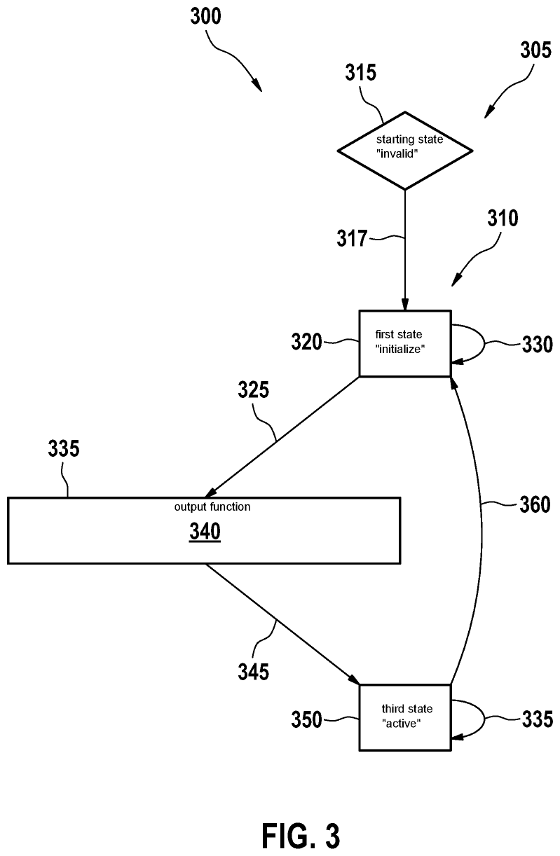

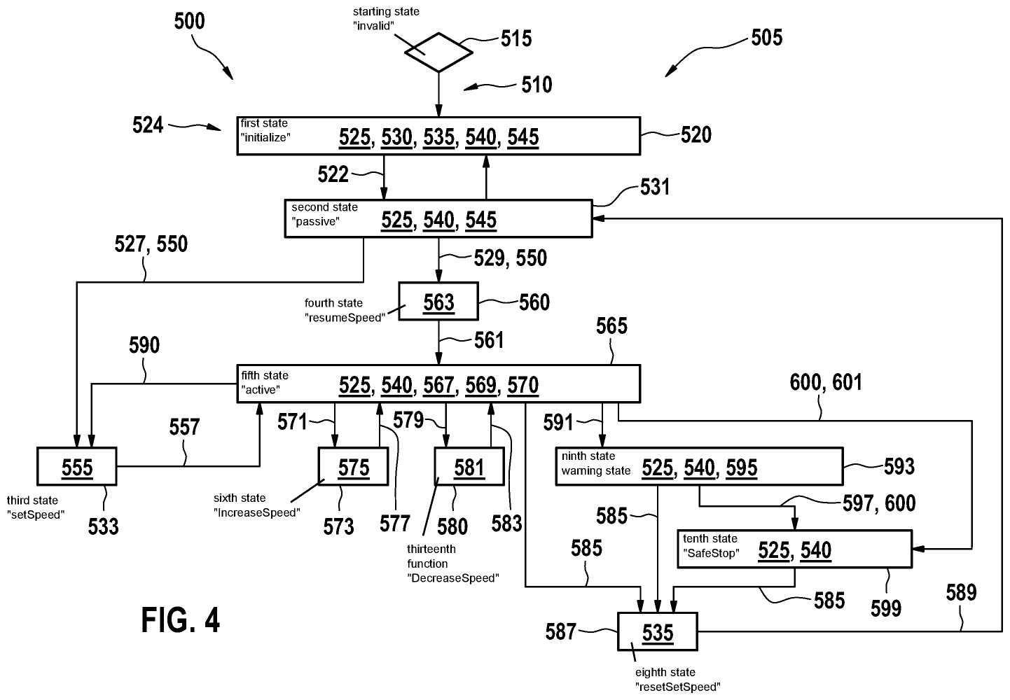

FIG. 1A shows a schematic illustration of a computer 100, and a machine-readable memory medium 105 that includes a computer program 110. Computer program 110 includes commands which, when computer program 110 is executed by computer 100, prompt computer 100 to carry out a provided method 200 for controlling a plurality of driving functions in an automated or autonomous vehicle 120. In the illustration in FIG. 1A, machine-readable memory medium 105 is designed as an external memory medium, for example. However, in one alternative embodiment it may also be integrated into computer 100. For example, computer 100 may be used in a development vehicle. In the context of the automated or autonomous driving, the plurality of driving functions in provided method 200 is in each case implemented by finite state machines (FSMs). The provided structures of FSMs 300, 500 in FIGS. 3 and 4, respectively, are explained in greater detail below, and may be used without limitation in FIGS. 1A and 1B. At least one FSM is of the Moore type, and includes a structure that is accessible during runtime, i.e., allows access to the structure and the option to change the structure. In the implementation that is accessible during runtime, the FSM may be used, for example, directly on computer 100 in the development vehicle during the development period, and may be visualized during travel (for debugging, for example). On this basis, for example C++ program code which is executed by a control unit 115 in final vehicle 120 in FIG. 1B for controlling the driving function, based on the provided FSM structure, may be automatically generated, i.e., is carried out based on provided method 200.

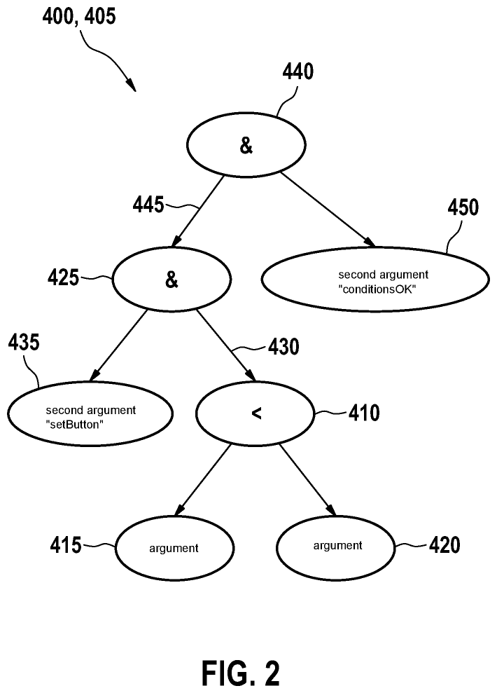

FIG. 2 shows a schematic illustration of a tree structure for implementing a formula language 400 for a finite state machine (FSM), based on above-mentioned method 200 for controlling a driving function of a vehicle in FIG. 1B. As mentioned above, at least one FSM of provided method 200 is an output state machine of the Moore type, and includes a structure with a finite set of states including a starting state.

The states are linked to one another via edges, the edges defining transitions between the states, provided that an edge condition in question is satisfied. For example, the edges correspond to inputs and the states correspond to the outputs. The internal behavior of the FSM is described by the number of states and the type of transitions (“Under which circumstances is a change made from state A into state B”). In each state (Moore type) or at each transition (Mealy type), actions are stored which define the external effect of the FSM. In particular, an FSM is incorporated into automated or autonomous vehicle 120 in FIG. 1B or alternatively, into the overall system of a machine, in that system variables define which transitions are made (input), and the states in each case trigger an action, i.e., effectuate a change of system variables (output). For defining the transitions, i.e., for formulating the edge condition between the states, a formula language F, 400 is used which links the system variables (input) to one another via operators.

For example, formula language F, 400 for the FSM is defined as follows:

1) Numbers c are an element of formula language F, 400: c∈F; this applies for all real numbers c (approximated by a floating point number, a natural number, or a Boolean value (1=true, 0=false)). Alternatively, formula language F, 400 may also include arbitrary characters d, d E F, where characters d include, for example, letters, special characters, etc., and may be concatenated in the form of “strings.” A range of numbers, or alternatively a range of characters, is thus established.
2) Names of variables x are an element of F, 400: x∈F, for all x of a finite set of predefined variables that may contain a number and/or an arbitrary character d, and/or a number and multiple arbitrary characters d as in item 1). Variables may in particular be linked to system variables, i.e., may accept and change their values, or may exist unlinked in the FSM.
3) Logical and comparative operators are part of F, 400: For all arguments a, b∈F:
a & b (AND)
a|b (OR)
a==b (EQUAL TO)
a !=b (NOT EQUAL TO)
a>b (GREATER THAN)
a<b (LESS THAN)
a>=b (GREATER THAN OR EQUAL TO)
a<=b (LESS THAN OR EQUAL TO)

If arguments a, b are strings, for example the “less than or equal to” operator is in each case applicable only to the individual characters of the string.

Conditional operators are utilized primarily for output functions in the states, an output function being called up if the state in question arises. This means that conditional operators are used, for example for cond, command1, command2 ∈F, 400, where cond indicates a condition and command1, command2 generally represent, for example, the actions to be carried out in the output function:
if(cond, command1)
if else(cond, command1, command2)

If multiple actions (command1, command2, etc.) are carried out in succession, a sequential execution operator>>for command1, command2, . . . ∈F, 400 may be utilized:
command1>>command2>>command3>> . . .

Depending on the application, further operators such as arithmetic operators may be provided:
a+b
a−b
a*b
a/b,
% (modulo), etc.

For output functions that are called up as output in the states, exclusively one additional output operator is contained. The output operator may be designed as a set operator, for example, in order to change a system variable or a variable as follows:
set_x(f) for a variable x, and a formula f∈F, 400 sets x to the value of f (where f, for example, contains no further set operator).

If used formula language F, 400 itself is representable in the form of a structure of an FSM, an automatic translation of the provided structure of the FSM may advantageously be carried out in a model-checkable format in order to carry out a correctness check of the FSM by model checking. For example, for this reason the formula language used includes no loops (while, for, etc.), since these structures would be too complex for the automatic translation or a subsequent model checking. Based on provided formula language F, 400, in particular even complex structures in the transitions may be made accessible and changeable during runtime in a consistent form.

Based on the formula language, FSM 300 may be defined in that at each fixed point in time a formula 405, f∈F, via the present assignment of the system variables, which include input variables and output variables, may be evaluated as a numerical value, of which the state transition is made a function of in FSM 300. A state transition is referred to as “inactive” when corresponding formula 405 is evaluated as 0 (zero), and otherwise is referred to as “active.” As the result of an active transition, the corresponding successor state is the next to be attended to if it is the single active transition of the present state. If multiple or no transitions are active, special behaviors are defined.

FSM 300 typically remains in the present state for as long as there are no active transitions. If there are multiple active transitions, they are executed in the established execution sequence of edges 310. The behavior of FSM 300 may thus be completely determined by resorting edges 310 in the code. Edges 310 and states 310 of FSM 300 may be accessed during runtime. This means that edges 310 or states 305 of FSM 300 may be changed, for example deleted, during runtime, in contrast to “conventional” FSM, whose structure is not accessible during runtime. In particular, the state of provided FSM 300 is unambiguously determined. If a state 305 includes more than one outgoing edge 310, the execution sequence of edges 310 may be indicated by priority numbers.

Building on formula language F, 400, further elements are defined for describing FSM 300:
finite state set S, 305,
finite set of triplets S×S×F that define transitions from one state into another,
state transition function δ which as a function of the active transitions of a state determines the successor state, it being possible for the state transition function to correspond, for example, to the edge condition between the states, i.e., from a starting state to a target state,
association mechanism which ensures that memory areas (or alternatively, variables) are connected to allow values to be linked, output mechanism which assigns to each state 305 of FSM 300 a list of output functions 340 to be carried out.

An output function 340 utilizes the output operator, which is designed as a set operator, to change system variables. An output function 340 may have a mixed form between an FSM and program code. The output mechanism is explained in greater detail below with reference to FIG. 3.

For example, with the aid of the association mechanism a memory area of FSM 300 may be connected to an external memory area in order to make external data accessible to FSM 300. This may include individual variables or more complex structures, for example a 2D array, a 3D array, etc. For example, an FSM internal 3×k array may correspond to the following external data: distance s, speed v, acceleration a via k automobiles in neighboring traffic, from which FSM 300 may read. In other cases, FSM 300 may also write into such data fields and thus change the external values.

The provided FSM 300 is triggered, for example, by calling up a step method, which in contrast to implementations that respond to events requires no further parameters. A call-up of a step converts FSM 300 into the next state, i.e., the edge condition as defined by state transition function δ, and carries out associated output functions 340. Various implementations of the response to deadlocks (state without active transitions) or nondeterminism (state with more than one active transition) are possible, as described above. In one alternative embodiment, it is also possible to require a limitation to deterministic FSMs. An FSM 300 defined in this way or a structure of FSM 300 defined in this way is accessible when all the above elements are implemented as structures that are available during runtime (including formulas f, 405 for the edge conditions, which essentially describe the transitions; but without transition function δ itself, which is part of the static definition of the FSM and implements the basic logic that a formula evaluated as true makes the associated edge active).

For example, based on formula language F, 400 explained above, three system variables “setButton,” “speed,” and “conditionsOK” as well as the constant value 130 may be combined into a formula 405

setButton & speed<130 & conditionsOK

Formula 405 is illustrated by way of example as a tree structure in FIG. 2 and includes three subconditions. First subcondition 410 includes a comparative LESS THAN (<) operator, which includes a first argument 410 that is formed by the system variable “speed,” and a second argument 420 that is formed by the constant value 130. Accordingly, first subcondition 410 is speed<130. A second subcondition 425 includes a logical AND operator (&), and as a first argument 430 of the second subcondition includes first subcondition 410 together with arguments 415, 420. A second argument 435 of the second subcondition is formed by the system variable “setButton.” Second subcondition 425 is thus setButton & (speed<130). A third subcondition 440 includes a logical AND operator (&), and as a first argument 445 includes second subcondition 425 together with arguments 415, 420, 435. Third subcondition 440 includes the system variable “conditionsOK” as a second argument 450. For example, based on an additional system variable “targetSpeed,” an output function
set targetSpeed(speed)
may be defined.

Based on formula language 400 explained for FIG. 2 and formula 405, a first specific embodiment 300 of a finite state machine (FSM) as shown in a graphical illustration in FIG. 3 may be defined for describing a first driving function for vehicle 120 illustrated in FIG. 1B. The first driving function may be designed as a simplified adaptive cruise control (ACC) driving function, i.e., as an adaptive cruise control system. The FSM includes a finite set of states 305 and edges 310 which connect states 305. Of the states 305, one state is designed as starting state 315. For example, starting state 315 is designed as an invalid starting state “invalid,” according to which a jump is immediately made into first state 320, which is designed as “initialize,” via edge 317 having the 1, which corresponds to the Boolean value “true.” For example, in first state 320 “initialize,” no changes of system variables are made; instead, a signal of system variable “conditionsOK”

conditionsOK=true
is merely awaited, which for example at the same time forms a first edge condition 325 for a transition to a second state 335. First edge condition 325 may include a priority with which an execution sequence of edges 310 is established. For example, the highest priority may be set to the value zero, the priorities then decreasing with increasing value. First edge condition 325 may thus be defined as follows:
conditionsOK<0>,
where <0> indicates the above-mentioned priority. If first edge condition 325 is satisfied, a change is made into second state 335. If first edge condition 325 is not satisfied, but instead a second edge condition 330 is satisfied, which may be defined, for example, as
not(conditionsOK)<1>,
i.e., for example as a negated value of the above-described signal of system variable “conditionsOK” having a lower priority <1> than first edge condition 325, the system remains in first state 320 “initialize.” The residence time in first state 320 may last until first edge condition 325 is satisfied.

If a change is made into second state 335 as described above, which is designed as a “set” state, for example, an output function 340 is called up. Output function 340 is built up as follows, for example as C++ program code:

```
ifelse (speed <= 130, //condition
  set_target(speed), //THEN case
  set_target(130)) //ELSE case
```

This means that output function 340 sets above-mentioned system variable “targetSpeed” to the value of the system variable “speed” if the system variable does not exceed the maximum value 130; otherwise, it sets the value to 130. In particular, above-described output function 340 in C++ program code represents an example of a mixed form of an FSM and program code.

In the stated example, output function 340 itself makes a decision, which in principle could also take place on the FSM level. Thus, from the first state 320 “initialize,” in second state 335 one of two different output operators, in each case implemented as a set operator, could be skipped over in output function 340, depending on whether speed<=130 or speed>130. One set operator sets the value of “target” to the value of “speed,” and the other set operator sets the value to 130. Accordingly, output function 340 including the two set operators could in turn be divided into a structure of a lower-order finite state machine, so that, for example, second state 335 subsequently includes only one set operator. All FSMs with the provided structure have this property of the divisibility of an output function into a structure of a lower-order FSM. After the system variable “target” has been changed, FSM 300 jumps into a third state 350, since a third edge condition 345 is set to the value “true” or 1, for example, and is accordingly satisfied. Third state 350 is designed as an “active” state, for example. The state machine remains in third state 350 for as long as the system variable “conditionsOK” contains the value “true”; i.e., a fourth edge condition 355 is satisfied which may be defined analogously to above first edge condition 325, also with the above-described priority.

If the system variable “conditionsOK” no longer includes the value “true,” i.e., a fifth edge condition 360 is satisfied, FSM 300 jumps back into first state 320. Fifth edge condition 360 may be designed analogously to above second edge condition 330 together with priority. For the simple example, no changes of system variables are made, either into first state 320 “initialize” or into third state 350 “active,” which is atypical for an actual driving function. Nevertheless, in the illustrated example in FIG. 3, further set operators could be present in first state 320 and in third state 350.

FIG. 4 shows a schematic illustration of a second specific embodiment of a finite state machine 500 for controlling a second driving function/real driving function of vehicle 120 in FIG. 1B. For example, the second driving function is designed as a lane-keeping assistant with cruise control and adaptive cruise control for expressway travel for vehicle 120. For example, this may be a more complex ACC system than for FSM 300 in FIG. 3. FSM 500 in FIG. 4 is shown in a graphical illustration, and, the same as FSM 300, includes a finite set of states 505 and edges 510 which link the states together according to above-mentioned transition function δ transition function δ evaluating an edge condition that is provided as a formula. Only the edge condition is addressed in the following discussion. Of states 505, one state is designed as a starting state 515. For example, starting state 515 is designed as an invalid starting state “invalid,” according to which a jump is made into first state 520, which is designed as “initialize,” via the edge having the 1, which corresponds to the Boolean value “true.” In “initialize” state 520, FSM 500 carries out in succession various output functions 524 contained in state 520 in order to change system variables. In the present exemplary embodiment, this is in C++ program code (object-oriented implementation), for example, which is not explicitly stated below:

A first function 525, in which various timers for user inputs are set and a response is made to a changed signal of a user during the input. In the following discussion, “@” in each case corresponds to an operator that generates the address of the variables (call by value). In particular, a rising edge computation for activating a user button is carried out as a user input:

everyStepCallback( ) :=
( ( ( ( ( ( ( ( ( ( ( ( ( ( ( (set(@mainButtonRising, risingEdge(mainButton,
mainButtonOld) ) >> set(@mainButtonOld, mainButton) ) >>
set(@setButtonRising, risingEdge(setButton, setButtonOld) ) ) >>
set(@setButtonOld,
setButton) ) >> set(@resumeButtonRising, risingEdge(resumeButton,
resumeButtonOld) ) ) >> set(@resumeButtonOld, resumeButton) ) >>
set(@speedPlusButtonRising, risingEdge(speedPlusButton,
speedPlusButtonOld) ) ) >> set(@speedPlusButtonOld,
speedPlusButton) ) >> set(@speedMinusButtonRising,
risingEdge(speedMinusButton, speedMinusButtonOld) ) ) >>
set(@speedMinusButtonOld, speedMinusButton) ) >>
set(@hasyVehicleSpeedKMH, min(200, ( (hasyVehicleSpeed * 36) /
10) ) ) ) >> set(@hwaReadyToActivate, isAllowedToDrive( ) ) ) >>
set(@indicatorSet, isIndicatorSet( ) ) ) >>
ifelse(isNotAllowedToDriveRaw( ),
set(@failureToleranceCycleCounter, min(1,
(failureToleranceCycleCounter + 1) ) ),
set(@failureToleranceCycleCounter, 0) ) ) >>
set(@isActuatorStandbyTolerated, 0) ) >>
ifelse(((enum_stateTransition_newStateEntry ==
hasMachineTransitioned) : (enum_externalState_passiveState ==
extFctState) ), (set(@tolerateActuatorStandbyCounter, 0) >>
set(@isActuatorStandbyTolerated,
1) ), if ( ( (tolerateActuatorStandbyCounter <
numberOfToleratedActuatorStandbyCycles) ),
(set(@tolerateActuatorStandbyCounter, min (1,
(tolerateActuatorStandbyCounter + 1) ) ) >>
set(@isActuatorStandbyTolerated, 1) ) ) ) ) >> ifelse(indicatorSet,
(set(@indicatorLeverStateTimeCounter, 1) >>
set(@indicatorHasBeenSet, 1) ),
ifelse( ( (indicatorLeverStateTimeCounter >=
expectedFctCycleTime) ), set(@indicatorLeverStateTimeCounter,
max (0, (indicatorLeverStateTimeCounter − expectedFctCycleTime) ) ),
set(@indicatorHasBeenSet, 0) ) ) ) >>
ifelse(((enum_indicatorLeverState_left == indicatorLeverState) ),
set(@lastIndicatorDirection, enum_indicatorLeverState_left),
if( ( (enum_indicatorLeverState_right == indicatorLeverState) ),
set(@lastIndicatorDirection, enum_indicatorLeverState_right) ) )

A second function 530, in which a speed that is resumed after an action, for example a user input for increasing/decreasing the speed of vehicle 120, is reset:

resetResumeSpeed( ) :=
set(@hmiResumeSpeed, 0)

A third function 535, in which an established speed is reset:

resetSetSpeed( ) :=
set(@hmiSetSpeed, 0)

A fourth function 540, in which state transition is externally handled for the surrounding system:

mainStateTransition(.) :=
ifelse( ( (extFctState == p_(0) ) ), set(@hasMachineTransitioned,
enum_stateTransition_noTransition), (set(@extFctState, p_(0) ) >>
set(@hasMachineTransitioned,
enum_stateTransition_newStateEntry) ) )

A fifth function 545, in which escalation states are reset:

resetEscalationStates( ) :=
(set(@escalationLevelDriverInteraction,
enum_escalationLevel_zero) >>
set(@escalationLevelVehicleStandStill,
enum_escalationLevel_zero) ) >>
set(@escalationLevelUnforseeableSystemBoundary,
enum_escalationLevel_zero)

If a subsequent first edge condition 522

conditionsOk & mainButtonRising <0>
is satisfied, FSM 500 changes into a second state 531 that is designed as a “passive” state, for example, the term “passive” expressing, for example, that no active user interaction is required in this state. “mainButtonRising” likewise refers to a system variable that has already been preprocessed in first state 520 within the scope of carrying out first function 525. Otherwise, i.e., if first edge condition 522 is not satisfied, FSM 500 remains in first state 520, or FSM 500 may change from second state 531 back into first state 520 via the returning edge (without reference numeral) with the edge condition mainButtonRising.

In second state 531, FSM 500 carries out in succession various output functions 524 contained in state 531, for example above-mentioned first function 525, fourth function 540, and fifth function 545. Since multiple transitions are active for second state 531, indicated in FIG. 4 by the two edges for a third state 533 and for a fourth state 560 leading away from second state 531, an execution sequence of the edges is established, using the priority. When a second edge condition 527 having a higher priority than a third edge condition 529 is satisfied, FSM 500 changes into third state 533. Second edge condition 527 is as follows:

isAllowedToDrive( )& setButtonRising <1>, where
second edge condition 527 includes a sixth function 550 in which during the execution it is checked whether various boundary conditions apply, for example whether a hand brake is released (conditionsOK), vehicle 120 is on the expressway (geofencingOK), whether the user or driver presses the accelerator pedal (not(driverInterrupt)), etc.:

isAllowedToDrive( ) :=
( ( ( ( ( ( ( (speedValid & (hmiVehicleSpeed >= 10) ) & (hmiVehicleSpeed
<= 124) ) & conditionsOk) & driverMonitoringOk) & geofencingOk) &
not(driverInterrupt) ) & (escalationLevelDegradation ==
enum_escalationLevel_zero) ) & ( (actuatorStateLong ==
enum_actuatorState_active) : (actuatorStateLong ==
enum_actuatorState_standby) ) ) & ( (actuatorStateLat ==
enum_actuatorState_active) : (actuatorStateLat ==
enum_actuatorState_standby) )

In third state 533, which is designed as a “set” state, for example, FSM 500 carries out a seventh function 555 as an output function in which a present speed of vehicle 120 is to be changed by user input:

setSpeed( ) :=
set(@hmiSetSpeed, hmiVehicleSpeed) >>
set(@hmiResumeSpeed, hmiSetSpeed)

After carrying out the output function in third state 533, FSM 500 skips over a fourth edge condition, which is always regarded as satisfied, into a fifth state 565. Fifth state 565 is designed as an “active” state, for example; i.e., an increase or decrease in the speed of vehicle 120 is requested by the user or driver. Even if second edge condition 527 is not satisfied, but third edge condition 529

isAllowedToDrive( ) & (resumeButtonRising &
(hmiResumeSpeed >= 10) ) <2>

is satisfied via sixth function 550 and further system variables, which have already been preprocessed within the scope of carrying out first function 525 in first and second states 520, 531 and carrying out second function 530 in first state 520, FSM 500, via a fourth state 560 including an eighth function 563, passes into fifth state 565.

Eighth function 563 forms the counterpart to second function 530, according to which, with the aid of eighth function 563, the speed is set to a value that differs from the reset value:

resumeSpeed( ) :=
set(@hmiSetSpeed, hmiResumeSpeed)

After carrying out eighth function 563, FSM 500 changes into fifth state 565 via a fifth edge condition 561, which is always true. The FSM carries out various output functions in succession in fifth state 565. These are in particular:

above-mentioned first function 525 and fourth function 540, and a ninth function 567, with the aid of which a lane change is handled:

handleLaneChange( ) :=
if( (indicatorHasBeenSet & handsOn),
set(@isLaneChangeActive, 1) ) >>
if( (egoCenteredInLane & not(indicatorHasBeenSet) ),
set(@isLaneChangeActive, 0) )

A tenth function 569, with the aid of which a movement of vehicle 120 is checked and a timer is set:

handleStandstill( ) :=
ifelse( ( (hasyVehicleSpeedKMH >= 5) ), set(@vehicleStandStill, 0),
ifelse(not(vehicleStandStill), set(@vehicleStandStill, 1),
set(@vehicleStandStillTimer, 10000) ) ) >> if(vehicleStandStill,
ifelse( ( (vehicleStandStillTimer > expectedFctCycleTime) ),
set(@vehicleStandStillTimer, max (0, (vehicleStandStillTimer −
expectedFctCycleTime) ) ), set(@escalationLevelVehicleStandStill,
enum_escalationLevel_one) ) )

An eleventh function 570, with the aid of which a response by the driver is acted on, for example a braking operation, and an escalation level is subsequently set:

handleDriverInterrupt( ) :=
if(driverInterrupt, set(@escalationLevelDriverInteraction,
enum_escalationLevel_one) )

For example, various active edges having different priorities lead away from fifth state 565. A sixth edge condition 571 for a sixth state 573, for example, has a higher priority than an eighth edge condition 579 for a seventh state 580, a tenth edge condition 585 for an eighth state 587, a twelfth edge condition 590 for third state 533, a thirteenth edge condition 591 for a ninth state 593, and a fifteenth edge condition 601 for a tenth state 599.

Sixth edge condition 571 is
speedPlusButtonRising <0>

This means that upon a successful check of the activation of a speed increase field or a speed increase button or a speed increase lever, etc., expressed by the system variable “speedPlusButtonRising” which is already preprocessed in first function 525, FSM 500 changes into sixth state 573, designed as an “IncreaseSpeed” state, and carries out a twelfth function 575 as an output function.

The requested speed increase is implemented with the aid of twelfth function 575:

increaseSetSpeed( ) :=
set(@hmiSetSpeed, min( ( (trunc
(hmiSetSpeed / 5) + 1) * 5), 120) ) >>
set(@hmiResumeSpeed, hmiSetSpeed)

A return is subsequently made back into fifth state 565 via a seventh edge condition 577 that is always true. Upon a successful check of the activation of a speed decrease field or a speed decrease button or a speed decrease lever, etc., expressed by the system variable “speedMinusButtonRising” which is already preprocessed in first function 525, FSM 500 changes into seventh state 580, designed as a “DecreaseSpeed” state, and carries out a thirteenth function 581 as an output function.

The requested speed decrease is implemented with the aid of thirteenth function 581:

decreaseSetSpeed( ) :=
set(@hmiSetSpeed, max( ( (trunc
( (hmiSetSpeed + 4) / 5) − 1) * 5),
5) ) >> set(@hmiResumeSpeed, hmiSetSpeed)

A return is subsequently made back into fifth state 565 via a ninth edge condition 583 that is always true. When tenth edge condition 585, which for example includes the following function for switching off the system

resetCondition( ) :=
mainButtonRising : isNotAllowedToDrive( )

is satisfied, FSM 500 jumps into an eighth state 587 that includes third function 535, and carries out same in order to reset the speed. FSM 500 goes back into second state 531 via an eleventh edge condition 589 that is always true. When a twelfth edge condition 590 is satisfied, FSM 500 passes from fifth state 565 into third state 533. Twelfth edge condition 590 is as follows, for example,

setButtonRising & ( (hmiVehicleSpeed >= 10) &
(hmiVehicleSpeed <= 124) ) <3>

and includes the system variables already preprocessed in first function 525 (setButtonRising) and in sixth function 550 (hmiVehicleSpeed). When a thirteenth edge condition 591, which for example includes the following function:

warningEscalation( ) :=
(escalationLeveldriverMonitoring == enum_escalationLevel_two) :
(escalationLevelGeoFencing == enum_escalationLevel_two)

is satisfied, in order to form a warning, FSM 500 jumps from fifth state 565 into a ninth state 593. Ninth state 593 is designed as a warning state, for example, and includes first function 525, a fourteenth function 595, and fourth function 540, which are carried out in succession as output functions.

With the aid of fourteenth function 595, a warning state is generated via safety switchoff request and a safety switchoff timer is set:

warningState( ) :=
ifelse( ( (extFctState != enum_externalState_warningState) ),
set(@safeStopTimer, 0), set(@safeStopTimer, min(10000,
(safeStopTimer + expectedFctCycleTime) ) ) ) >>
ifelse( ( (safeStopTimer > 5000) ),
set(@safeStopRequested, 1), set(@safeStopRequested, 0) )

Two edges lead away from ninth state 593, one to a tenth state 599 and one to eighth state 587. When a fourteenth edge condition 597 is satisfied, a fourteenth edge condition 597 results in FSM 500 changing from ninth state 593 into tenth state 599.

Fourteenth edge condition 597 is as follows, for example:

safeStopRequested : ( (escalationLeveldriverMonitoring ==
enum_escalationLevel_three) : geoFencEscalation( ) ) <0>
and includes the following fifteenth function 600
geoFencEscalation( ) :=
(escalationLevelGeoFencing == enum_escalationLevel_three) :
(escalationLevelDegradation == enum_escalationLevel_one)

in order to prepare the safety switchoff by setting an escalation level. In tenth state 599, which is designed as a “SafeStop” state, for example, FSM 500 carries out first function 525 and the fourth function. FSM 500 subsequently carries out tenth edge condition 585, using the above-mentioned function “resetCondition( )” which is to result in switching off of the system, and places FSM 500 in eighth state 587 in order to reset the speed of vehicle 120.

When fifteenth edge condition 601 is satisfied, FSM 500 jumps from fifth state 565 into tenth state 599. Fifteenth edge condition 601 includes above-mentioned fifteenth function 600, for example.

Further functions of FSM 500 in FIG. 4, which within the scope of carrying out above output functions 524 are utilized in the states, form the following:

actuatorStateDrivingOk( ) :=
isLaneChangeActive & (isActuatorStandbyTolerated :
(actuatorStateLong == enum_actuatorState_active) ) :
not(isLaneChangeActive) & (isActuatorStandbyTolerated :
(actuatorStateLong == enum_actuatorState_active) &
(actuatorStateLat == enum_actuatorState_active) )
isIndicatorSet( ) :=
(indicatorLeverState == enum_indicatorLeverState_left) :
(indicatorLeverState == enum_indicatorLeverState_right)
isNotAllowedToDrive( ) :=
isNotAllowedToDriveRaw( ) & (failureToleranceCycleCounter >= 1)
isNotAllowedToDriveRaw( ) :=
( ( ( (not(speedValid) : not(conditionsOk) ) : (hmiVehicleSpeed >=
125) ) : driverInterrupt) : (escalationLevelVehicleStandStill ==
enum_escalationLevel_one) ) : not(actuatorStateDrivingOk( ) )
risingEdge(..) :=
p_(0) & not(p_(1) )

To avoid repetitions, redundant descriptions of actions in states and transitions which may similarly also be achieved by lower-priority edge conditions have been dispensed with. Nevertheless, these actions and transitions may be carried out without limitation. In particular, the provided structure of FSM 500 in FIG. 4 and of FSM 300 in FIG. 3 in each case includes no end state.

During runtime it is known in which state FSM 500 is in, and which transition sequence has resulted in this state. In addition, the exact implementation of the edge conditions and output functions 524 is known (cf. the above-mentioned code for the individual functions, which includes the content of the edge conditions and output functions 524), as well as the assignment of all utilized system variables. Consequently, the state and the overall structure of FSM 500 during runtime are unambiguously known, and all components that are relevant for the operation are explicitly available during runtime, which makes the internal behavior of FSM 500 “transparent.” The above edge conditions form the formulas, which are made up of system variables, numbers, logical operators, and above-described nested functions. For FSM 500 illustrated in FIG. 4, the above definition of FSM 300 may be transferred without limitation. In addition, the formula language underlying FSM 500, as explained with reference to FIG. 2, may likewise be illustrated as a tree structure. However, for the sake of simplicity this did not take place for the exemplary embodiment in FIG. 4. Due to the above-defined formula language, which is used in above-described output functions 524 of FSM 500 in FIG. 4, all output functions 524 themselves may be represented as an FSM or as a lower-order FSM of FSM 500 in FIG. 4. In particular, FSM 500 in FIG. 4 includes mixed states, i.e., states which in addition to the FSM structure also include C++ program code as functions that are dividable into lower-order FSM structures.

FSM structures 300, 500 in FIGS. 3 and 4 are particularly preferably suited, for example, for the object-oriented implementation in the C++ programming technique. In principle, however, an implementation of the provided FSM structure is not limited to this programming technique or to object-oriented programming, and alternatively may be achieved using any other programming language. In addition, the FSM structure is not limited to an object-oriented implementation.

In one alternative embodiment of the provided FSM structure in FIG. 4, the prioritization for tenth edge condition 585, thirteenth edge condition 591, and fifteenth edge condition 601 may take place in a different way in order to bring the system, i.e., vehicle 120, to an actual shutdown for the case that system variables such as “conditionsOK” no longer have the value “true.” For example, the priorities of the individual stated edge conditions may in each case be set to higher values of zero, one, etc. Due to a differing prioritization, the situation may advantageously be avoided that a user or an unauthorized external third party may keep the system active, in that this person generates a recurring signal speedPlusButton or speedMinusButton, so that FSM 500 would in each case carry out only the transitions using sixth edge condition 571 and eighth edge condition 579, and no switchoff of vehicle 120 would be prompted.

The fact that a differing prioritization as described above may take place may have been ascertained, for example, based on the model checking proof of correctness, in that FSM 500 itself has been subjected to such proof in a formal language, for example linear temporal logic (LTL), and the model checking for the stated example has generated a counterstatement. The counterstatement may be designed in the form of an infinite loop, which indicates that switching off of vehicle 120 is prevented under a certain prioritization of the edge conditions. In particular, based on the proof, the reliability of the driving function to be controlled via FSM 500 may be improved. This is difficult to demonstrate via a test drive with vehicle 120 or a simulation. In addition, with the aid of the provided model, i.e., the structure of the FSM, which in particular is adapted to the model checking proof, a contribution to increasing the safety may be made, provided that the driving function in question is used in an automated or autonomous vehicle 120 that is to be newly authorized, and it has previously been proven that FSM 500, i.e., the model, is correct.

In a further alternative embodiment, the structure of FSM 500 in FIG. 4 may be further simplified by dividing each output function, in a state including more than one output operator, into a lower-order FSM structure. This is not illustrated in FIG. 4.

The present invention has been described in detail using preferred exemplary embodiments. Instead of the described exemplary embodiments, further exemplary embodiments are possible which may include further modifications or combinations of described features. For this reason, the present invention is not limited by the provided examples, since other variations may be derived therefrom by those skilled in the art without departing from the scope of protection of the present invention.

What is claimed is:

1. A method for controlling a plurality of driving functions in an automated or autonomous vehicle, the method comprising the following steps:
describing each of the plurality of driving functions by a respective finite state machine, at least one finite state machine of the finite state machines being a Moore type finite state machine including a structure with a finite set of states, the states being linked to one another via edges, each of the edges defining from the finite set of states a transition from a starting state to a target state, in that an associated edge condition is true or false; and
making the at least one finite state machine accessible during runtime based on the structure, so that an access to the states and the edges is made possible to change the states and/or the edges.

2. The method as recited in claim 1, wherein a change of a state of the states and/or of an edge of the edges includes removing a state and/or an edge.

3. The method as recited in claim 1, wherein each of the edges include a respective input and each of the states includes a respective output, the inputs and outputs being described using system variables and a formula language, at least one system variable in each of the respective outputs is linked to a respective output function that is called up when the state including the respective output arises, the output function utilizing an output operator to change the at least one system variable linked to the output function.

4. The method as recited in claim 3, wherein the formula language includes logical operators and/or comparative operators and/or arithmetic operators and/or output operators and a range of numbers, and wherein the formula language is representable as a structure of a finite state machine.

5. The method as recited in claim 3, wherein, when a respective output function of a respection state includes at least two output operators, the respective output function is dividable into a structure of a lower-order finite state machine.

6. The method as recited in claim 1, wherein the edge condition includes a priority with which an execution sequence of the edges is established.

7. The method as recited claim 1, wherein the structure of the at least one finite state machine is reprentable as a graph, and the at least one finite state machine, based on the structure, is implemented using an object-oriented programming technique.

8. The method as recited in claim 1, wherein at least one of the driving functions is an adaptive cruise control system of the automated or autonomous vehicle.

9. A control unit configured to control a plurality of driving functions in an automated or autonomous vehicle, the control unit configured to:
describe each of the plurality of driving functions by a respective finite state machine, at least one finite state machine of the finite state machines being a Moore type finite state machine including a structure with a finite set of states, the states being linked to one another via edges, each of the edges defining from the finite set of states a transition from a starting state to a target state, in that an associated edge condition is true or false; and
make the at least one finite state machine accessible during runtime based on the structure, so that an access to the states and the edges is made possible to change the states and/or the edges.

10. A non-transitory machine-readable memory medium on which is stored a computer program for controlling a plurality of driving functions in an automated or autonomous vehicle, the computer program, when executed by a computer, causing the computer to perform the following steps:
describing each of the plurality of driving functions by a respective finite state machine, at least one finite state machine of the finite state machines being a Moore type finite state machine including a structure with a finite set of states, the states being linked to one another via edges, each of the edges defining from the finite set of states a transition from a starting state to a target state, in that an associated edge condition is true or false; and
making the at least one finite state machine accessible during runtime based on the structure, so that an access to the states and the edges is made possible to change the states and/or the edges.
